(19) United States
(12) Patent Application Publication
(10) Pub. No.: US 2026/0244170 A1
(43) Pub. Date: Aug. 20, 2026

(54) EXPLAINABLE MODEL MONITORING

(71) Applicant: Siemens Aktiengesellschaft, München (DE)

(72) Inventors: Heinrich Helmut Degen, Plainsboro, NJ (US); Christof J. Budnik, Hamilton, NJ (US); Michael Lebacher, Töging am Inn (DE); Ralf Gross, Allersberg (DE); Stefan Hagen Weber, München (DE)

(73) Assignee: Siemens Aktiengesellschaft, München (DE)

(21) Appl. No.: 19/159,538

(22) PCT Filed: Mar. 2, 2023
(86) PCT No.: PCT/US2023/063563

§ 371 Date: Aug. 25, 2025

(51) Int. Cl. G05B 13/02

(52) U.S. Cl. CPC G05B 13/028

(57) ABSTRACT

AI systems can define industrial AI models that perform, for example and without limitation, pattern recognition, trend prediction, or deviation identification. Furthermore, embodiments can automatically identify immediate and responsive actions to the detected deviations, and can automatically verify whether the identified actions are successful. Without being bound by theory, but by way of example, in some cases, embodiments described herein enable operators to monitor AI applications and respond to deviations within minutes, whereas current approaches might require data scientists to monitor and respond, and such a response might take days.

### BACKGROUND

Many industrial processes and machinery are monitored and controlled by operators or engineers. Such processes and machinery increasingly rely on artificial intelligence (AI) applications or systems to identify patterns, predict trends, and identify deviations across various industries. It is recognized herein many AI applications are not adequately monitoring or are not monitored at all, and of those that are monitored, current approaches to monitoring and maintaining the health status of such AI applications lack capabilities and efficiencies. For example, monitoring AI systems is typically labor-intensive work that requires skilled and highly paid data scientists. Furthermore, such work can often take significant time to detect, understand, and resolve a situation. The time or delays associated with monitoring and maintaining AI systems can result in non-conformance costs, recalls, and significant downtime, among other costs and negative effects.

### BRIEF SUMMARY

Embodiments of the invention address and overcome one or more of the described-herein shortcomings by providing methods, systems, and apparatuses that automatically detect deviations associated with AI applications (models) or systems. Such AI systems can define industrial AI models that perform, for example and without limitation, pattern recognition, trend prediction, or deviation identification. Furthermore, embodiments can automatically identify immediate and responsive actions to the detected deviations, and can automatically verify whether the identified actions are successful. Without being bound by theory, but by way of example, in some cases, embodiments described herein enable operators to monitor AI applications and respond to deviations within minutes, whereas current approaches might require data scientists to monitor and respond, and such a response might take days.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an example application domain, in particular an example industrial or manufacturing system, that can include one or more artificial intelligence (AI) models that define an AI solution domain for performing functions of the system, in accordance with an example embodiment.

FIG. 2 is a flow diagram that depicts operations that can be performed by a computing system of FIG. 1, so as to automatically detect and relate causes of events or changes (deviations) in the system to symptoms of the application domain and AI solution domain.

FIG. 3 is another flow diagram that depicts other operations that can be performed by the computing system, so as to automatically identify immediate and response actions in the application domain or AI solution domain in response to the deviations detected in FIG. 2, in accordance with another example embodiment.

FIG. 4 is another flow diagram that depicts other operations that can be performed by the computing system, so as to automatically determine whether the initiated action from FIG. 3 is effective and successful in accordance with an example embodiment.

FIG. 5 depicts a computing environment within which embodiments of the disclosure may be implemented.

FIG. 6 illustrates an example user interface that can be displayed in accordance with an example embodiment.

FIG. 7 illustrates an example user interface that can be displayed in accordance with an example embodiment.

FIG. 8 illustrates an example user interface that can be displayed in accordance with an example embodiment.

FIG. 9 illustrates an example user interface that can be displayed in accordance with an example embodiment.

### DETAILED DESCRIPTION

As an initial matter, artificial intelligence (AI) and particularly machine learning (ML) based technologies are used more and more in various aspects of life, including industrial applications. For example, ML-based technologies can assist in identifying patterns, trends, and deviations. The AI/ML domain can be referred to herein as the AI solution domain and ML-based technologies for pattern identification, trends, and deviations can be referred to herein as AI solution domain systems.

The AI solution domain systems have unique characteristics compared to a traditional rule-based system, for example, they define black-box systems and are non-deterministic. A black-box system refers to a system that is not human comprehensible as to how and why an output is calculated for a given input. In traditional, rule-based systems, algorithms with sequence of instructions are used that turn an input into an output. The sequence of instructions makes it human-comprehensible. The core mechanism an AI solution domain system uses is a trained model for which it is not comprehensible why an output for a given input A is calculated. By way of example of a non-deterministic system, if the same input is given to such a system, different outputs can be produced at different points in time. For example, an AI model can internally rely on stochastic sampling procedures or generally provide stochastic outputs. Due to the above-mentioned characteristics, it is recognized herein that many people do not understand and therefore do not trust the outcome of such AI domain systems. For example, in some cases, it is critical for a human to be able to understand the rationale for the calculations, so they can accept or reject the calculated outcome of an AI solution domain system.

Such AI solution domain systems can be constructed to monitor other systems that can be referred to herein as the application domain or application domain systems. Examples of such systems include, without limitation, manufacturing systems, energy generation systems, energy distribution systems, banking systems, insurance systems, medical applications, transportation applications, and infrastructure applications. Thus, for purposes of example, application domain and industrial (or manufacturing) system or domain can be used interchangeably, unless otherwise specified. For example, a manufacturing domain of a given industrial system can define various machines, materials, and processes configured to perform operations or produce an output (e.g., product). To cover the multiple aspects of an industrial system from the application domain, an AI solution domain system can consist of multiple sets of training data, models, etc. In some cases, to ensure that the AI domain systems are effective and efficient, they are monitored by an AI operator. In an example, a goal of an AI operator is to ensure that the AI domain systems stay within defined quality boundaries and that the uptime of the application domain systems (e.g., manufacturing, transportation, energy generation, etc.) is maximized, and that the application domain systems are effective and efficient.

It is recognized herein that identifying deviations in AI domain systems is a technical problem that is often not addressed in current systems. A deviation of an AI domain system can refer to a situation in which the AI domain system does not perform its function within the defined quality boundaries for selected metrics. An example for such a metric is the f1-score. An example defined quality boundary is a minimum threshold of 50% for the f1-score. Continuing with the example, if the f1-score drops below the 50% boundary for a certain amount of time, the AI domain system can be considered to be not working effectively and can require an intervention by the AI operator. It is further recognized herein that, in current approaches, such deviations are often not detected within a timely manner (e.g., hours). Furthermore, in current approaches, after the deviations are detected, it can take significant time (e.g., days) for a data scientist to find the root cause and to initiate an effective response action to resolve the root cause.

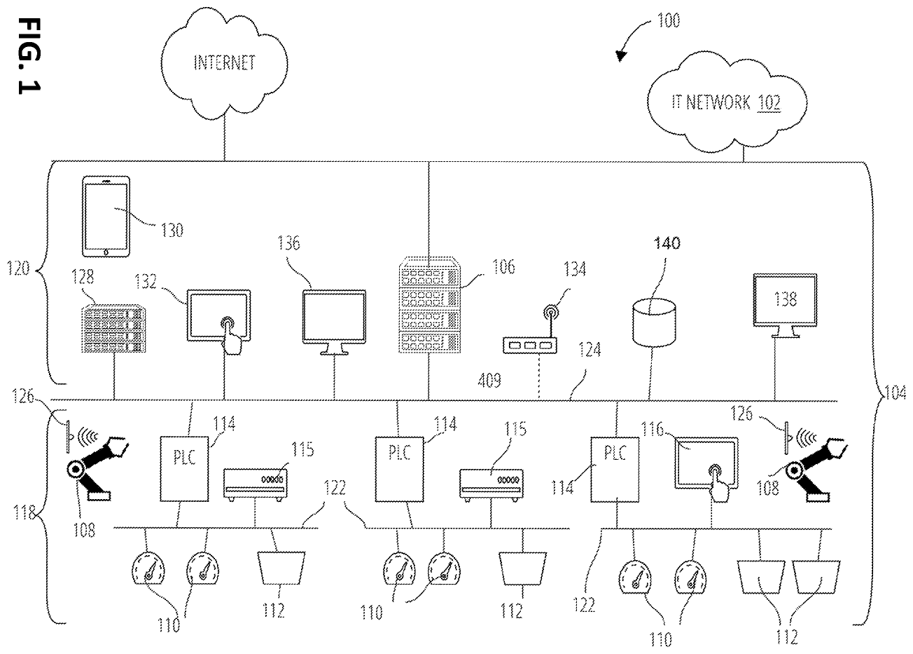

Referring initially to FIG. 1, an example industrial system 100 includes an office or corporate IT network 102 and an operational plant or production network 104 communicatively coupled to the IT network 102. It will be understood that the system 100 is illustrated and simplified as an example, and AI models from a variety of systems can be monitored and maintained in accordance with various embodiments, and all such systems are contemplated as being within the scope of this disclosure. For example, and without limitation, embodiments can be implemented in an operational technology system, energy generation system (e.g., wind parks, solar parks, etc.), an energy distribution network, manufacturing systems, banking systems, insurance systems, medical applications, transportation applications, and infrastructure systems.

The production network 104 can include a computing system or engine 106 that is connected to the IT network 102. The production network 104 can include various production machines configured to work together to perform one or more manufacturing operations. Example production machines of the production network 104 can include, without limitation, robots 108 and other field devices, such as sensors 110, actuators 112, or other machines, which can be controlled by a respective PLC 114. The PLC 114 can send instructions to respective field devices. In some cases, a given PLC 114 can be coupled to one or more human machine interfaces (HMIs) 116. The production network 104 can also define various application domain management systems or manufacturing domain management systems that can identify root causes (e.g., a first root cause or a root cause 1, further described herein). For example, an example manufacturing domain management system can manage a bill of material used in the production network 104.

The example system 100, in particular the production network 104, can define a fieldbus portion 118 and an Ethernet portion 120. For example, the fieldbus portion 118 can include the robots 108, PLC 114, sensors 110, actuators 112, and HMIs 116. The fieldbus portion 118 can define one or more production cells or control zones. The fieldbus portion 118 can further include a data extraction node 115 that can be configured to communicate with a given PLC 114 and sensors 110.

The PLC 114, data extraction node 115, sensors 110, actuators 112, and HMI 116 within a given production cell can communicate with each other via a respective field bus 122. Each control zone can be defined by a respective PLC 114, such that the PLC 114, and thus the corresponding control zone, can connect to the Ethernet portion 120 via an Ethernet connection 124. The robots 108 can be configured to communicate with other devices within the fieldbus portion 118 via a WiFi connection 126. Similarly, the robots 108 can communicate with the Ethernet portion 120, in particular a Supervisory Control and Data Acquisition (SCADA) server 128, via the WiFi connection 126. The Ethernet portion 120 of the production network 104 can include various computing devices communicatively coupled together via the Ethernet connection 124. Example computing devices in the Ethernet portion 120 include, without limitation, a mobile data collector 130, HMIs 132, the SCADA server 128, the abstraction engine 106, a wireless router 134, a manufacturing execution system (MES) 136, an engineering system (ES) 138, and a log server 140. The ES 138 can include one or more engineering workstations. In an example, the MES 136, HMIs 132, ES 138, and log server 140 are connected to the production network 104 directly. The wireless router 134 can also connect to the production network 104 directly. Thus, in some cases, mobile users, for instance the mobile data collector 130 and robots 108, can connect to the production network 104 via the wireless router 134. In some cases, by way of example, the ES 138 and the mobile data collector 130 define guest devices that are allowed to connect to the computing system 106. The computing system 106 can define one or more AI models configured to collect or obtain data related to the example industrial system 100.

Users of the system 100 can include, for example and without limitation, operators of an industrial plant or engineers that can update the control logic of a plant. By way of an example, an operator can interact with the HMIs 132, which may be located in a control room of a given plant. Alternatively, or additionally, an operator can interact with HMIs of the system 100 that are located remotely from the production network 104. Similarly, for example, engineers can use the HMIs 116 that can be located in an engineering room of the system 100. Alternatively, or additionally, an engineer can interact with HMIs of the system 100 that are located remotely from the production network 104.

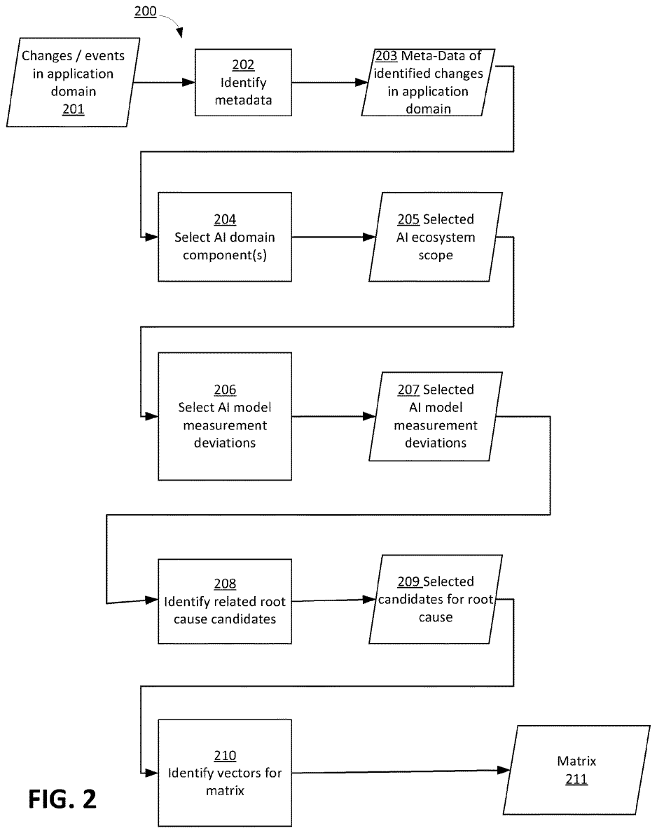

Referring now to FIG. 2, example operations 200 can be performed by a computing system, for instance the computing system 106. The operations 200 can be triggered by changes or events 201 in the application domain, for instance in the industrial system 100. Such events 201 can define candidates for a first root cause (root cause 1) described further herein. Examples of events 201 that can define first root causes (root cause 1) in the application (industrial) domain include, for example without limitation, defect of sensors or sensor decay, change of input materials, production of varying or different parameters, a new operator that controls the system 100 in an atypical or new way, etc. At 202, based on the changes/events 201, the system 106 can identify or determine metadata corresponding to the changes/events 201 in the application domain (e.g., industrial system 100). For example, in some cases, changes/events 201 are tracked in a log that maintains different parameter settings, or in shift log that tracks manufacturing changes, such as change of soldering paste, change in supplier for a particular material input, or the like. At 202, relevant metadata is extracted, such as, for example and without limitation, time stamps, relevant processes, locations of corresponding machinery, or other standardized information. Thus, in some examples, for each change or event in the application domain, a set of metadata is identified and stored, for instance as a metadata vector 203, which can also be represented as EventApplicationMetadataVector. The metadata vector 203 can include various data or information, by way of example and without limitation: an effective date of the event/change 201; an effective time of the event/change 201; a planned expiration date of the event/change 201; a planned expiration time of the event/change 201; a topology location of the event/change 201 (e.g., postal address, building, room, working or production area); a name of the changed component, material, or process step associated with event/change 201; or a description of the change 201. Table 1 further illustrates example metadata that can be identified or output at 202, based on changes 201 that occurred within a specific time interval (e.g., previous week).

TABLE 1

| Input | Output | Output | Output |
|---|---|---|---|
| Time frame | Production line | Machine | Change |
| Changes in | Soldering | Soldering | Soldering paste |
| last week | line 3-1 | station 12 | changed from P1 to |
| | | | P2 on Sep 19, 17:17 |
| Changes in | Soldering | Soldering | Transistor component |
| last week | line 3-1 | station 12 | changed from T1 to |
| | | | T2 on Sep 17, 17:17 |

With continuing reference to FIG. 2, at 204, based on the metadata vector 203, the system 106 can select one or more AI domain components, so as to generate an AI domain component vector 205, which can be represented as AIComponentVector. In some examples, the AI domain components are identified or selected as a consequence of the extracted metadata (e.g., metadata vector 203), which can connect the affected machinery and location (application domain components from affected manufacturing or production process) to the AI components employed in the affected manufacturing or production process. The AI domain component vector 205 can define a selected AI ecosystem scope. The AI domain component vector 205 can include, for example and without limitation, AI component names and AI component metrics. For example, for each input metadata vector 203, related AI components and metrics can be identified in a corresponding AI domain component vector 205. Table 2 further illustrates an example mapping table in which AI components and metrics are identified, at 204, based on the metadata vector 203, such that the metadata vector 203 is mapped to AI components. Example AI components include, without limitation, quality prediction systems with metric mean squared error (e.g., for measuring the agreement between the prediction and actual quality measurements), a parameter recommender (e.g., for providing proposals for optimal parameter settings) with a metric that relates to the output distribution of the proposed parameters, an anomaly detection system with a metric that provides anomaly detection scores together with measures for feature drifts, and the like. In some cases, the mapping can be static and deterministic, for example, when each AI component comes with a set of predefined metrics, and when the matching with the application domain (e.g., topology location and process components, etc.) is available from the metadata of the AI models. By way of example, given AI models can correspond with predefined metrics and metadata concerning their location in a given plant and the respective process step for which they are implemented. Thus, continuing with the example, the matching of the application domain to the AI model can result from a matching of the metadata between where an application domain event occurs to the location of the respective AI models.

TABLE 2

| | Name of changed | | |
|---|---|---|---|
| Topology | component, material, or | | |
| location | process step | AI component | AI metrics |
| Location 1 | Component 1 | AI component 1 | AI metrics 1 |
| Location 1 | Component 2 | AI component 1 | AI metrics 2 |
| Location 1 | Component 3 | AI component 2 | AI metrics 3 |
| Location 1 | Material 1 | AI component 2 | AI metrics 4 |
| Location 1 | Material 2 | AI component 2 | AI metrics 5 |
| Location 1 | Material 3 | AI component 3 | AI metrics 6 |
| Location 2 | Component 1 | AI component 4 | AI metrics 1 |
| Location 2 | Component 2 | AI component 4 | AI metrics 2 |
| . . . | . . . | . . . | . . . |

By way of further example, table 3 below illustrates that specific metadata, in particular a specific topology location and specific name of a changed component, material, or process step, is mapped (at 204) to an example AI component and an example AI metric.

TABLE 3

| | Input | | |
|---|---|---|---|
| | Name of changed | | |
| | component, | | |
| Input | material, or | Output | Output |
| Topology location | process step | AI component | AI metrics |
| Soldering line 3-1 | Soldering paste | Soldering | f1 score |
| Soldering station 12 | | paste model | |

Thus, in accordance with the example of Table 3, the vector 205 that is generated includes a soldering paste model as the selected AI component and a f1 score as the selected AI metric. At 206, based on the AI domain component vector 205, measurement deviations for the AI model are selected, so as to define one or more candidates for symptoms. Thus, a deviation vector 207 can be generated at 206, wherein the deviation vector 207 defines selected AI model measurement deviations (or candidates for symptoms). The deviation vector 207 can include, for example and without limitation, a metric; a before average value; an after average value, or a date and time of the change 201. It will be understood that while the example AI metric is an f1 score, alternative or additional metrics for label-based or label-free monitoring may be used, and all such AI metrics are contemplated as being within the scope of this disclosure. For example, and without limitation, MSE, an Out-of-Distribution score, or an input feature drift measure can define an AI metric herein. Regardless of the metric implemented, the system can determine what changed with a given AI value or metric at or around the time in the application domain event (e.g., change/event 201) occurs.

Table 4 illustrates example selected AI model measurement deviations that can be included in the deviation vector 207, based on the AI components and AI metrics of the vector 205.

TABLE 4

| Input | Input | Output |
|---|---|---|
| AI component | AI metrics | Metric deviation |
| Soldering paste model | f1 score | 19 Sep. 2022, 18:23, 0.38 |
| | | for 5 seconds |
| Soldering paste model | f1 score | 19 Sep. 2022, 22:23, 0.33 |
| | | for 1.5 seconds |
| Soldering paste model | f1 score | 20 Sep. 2022, 2:23, 0.213 |
| | | for 34 minutes |
| Soldering paste model | f1 score | 20 Sep. 2022, 3:34, 0.37 for |
| | | 57 minutes |
| Soldering paste model | f1 score | 20 Sep. 2022, 6:23, 0.37 for |
| | | 1 hour and longer |

Furthermore, at 206, the system 106 can analyze the deviations, for instance based on a threshold, and detect anomalies. By way of example, an anomaly can be detected if an f1 score falls below a predetermined threshold for a predetermined amount of time, for instance below 50% for an hour or more. Table 5 illustrates the aforementioned example threshold being applied, so as to detect an anomaly that can be output in the deviation vector 107.

TABLE 5

| | | | Output |
|---|---|---|---|
| Input | Input | Input | Anomaly |
| AI component | AI metrics | Metric deviation | detection |
| Soldering | f1 score | 19 Sep. 2022, 18:23, 0.38 | No |
| paste model | | for 5 seconds | |
| Soldering | f1 score | 19 Sep. 2022, 22:23, 0.33 | No |
| paste model | | for 1.5 seconds | |
| Soldering | f1 score | 20 Sep. 2022, 2:23, 0.213 | No |
| paste model | | for 34 minutes | |
| Soldering | f1 score | 20 Sep. 2022, 3:34, 0.37 | No |
| paste model | | for 57 minutes | |
| Soldering | f1 score | 20 Sep. 2022, 6:23, 0.37 | Yes |
| paste model | | for 1 hour and longer | |

With continuing reference to FIG. 2, based on the deviation vector 207 and the metadata vector 203, at 208, computing system 106 can identify related root cause candidates of the AI solution domain, so as to generate a selected candidates vector or a root cause vector 209 for a second root cause (root cause 2) that is associated with the AI solution domain. Thus, at 208, the identified changes 201 in the application domain (e.g., industrial system 200) can be matched or related to the AI solution domain, such that a given first root cause (root cause 1) can be linked to a given root cause (root cause 2). That is, at 208, a relationship between changes or events that occur in a given manufacturing system and AI models implemented by the manufacturing system can be defined.

In some cases, a change in the application domain precedes a change in the AI solution domain. Thus, if a domain event Xₜ happens at time t any relevant element of AIDeviation Y_{τ} can be cause by Xₜ if τ>t. Depending on the form of available data about Y_{τ}, Xₜ this relationship over time can be established in various ways by the system 106. In an example, in which Xₜ is a unique event with no continuous and consistent tracking over time, a threshold c and a suspected time interval I=[t, T] can be define, where T−t corresponds to the expected time until a change in the application domain will have an impact on the AI solution domain. When T is greater than the time of evaluation, the output can be supplemented by extensive logging that states that it is potentially too early to determine the effect of the application domain on the AI model domain. Alternatively, the system can determine whether Σ_{[t,T]}I(Xₜ>c)>0 for all Deviation vectors Xₜ (e.g., in case the threshold is always an upper bound).

In another example in which Yₜ and Xₜ are continuous measurements, the system can establish Granger (time-related) causality by modelling and checking whether equation (1) P(Y_{τ}|{Aₜ,Xₜ})≠P(Y_{τ}|Aₜ) is true. For example, if the application domain root cause Xₜ is causal over time for an AI deviation Y_{τ}, the predictive distribution P(Y_{τ}|{Aₜ,Xₜ}) considering Xₜ and the other relevant factors Aₜ (e.g., such as other application domain root causes or model inputs) can differ from the predictive distribution P(Y_{τ}|Aₜ) in which information related to Xₜ is deliberately hid. In various example, equation (1) can be implemented by a linear regression model with testing of the (lagged) coefficients on Xₜ or by any predictive machine learning model with a stochastic interpretation.

In either of the above-described examples, the system 106 can determine whether a change in the application domain triggers a change in the AI model domain. When such a trigger or relationship is detected, the change in model metrics Y_{τ} can be related to the input feature space, for example, to understand which change in the AI model domain feature space led to the change in the metrics. For example, it is recognized herein a transmission mechanism exists between the change in the application domain and the AI model domain, which runs through the feature space Fₜ. By way of example, if the soldering paste is changed in the application (manufacturing) domain, and the quality of the corresponding AI model deteriorates, the change in soldering paste should be related to the input features of the AI model: Xₜ→Fₜ→Yₜ. Thus, the AI model can be represented as f(Fₜ)=Ŷₜ, where f(Fₜ) is the AI model operating on features Fₜ producing an output Ŷₜ that can be transformed in the AI model deviation Yₜ=g(Ŷₜ). In an example, local XAI techniques are performed (e.g., LIME, SHAP, LRP, etc.) in order to decompose the predictions additively, which can represented according to Equation (2):

$${\hat{Y}}_{t} = {ϕ}_{t , 0} + {\sum }_{j} {ϕ}_{t , j} \qquad ( 2 )$$

Referring to Equation (2), φ_{t,j} represents the additive attribution of Feature F_{t,j} to the predictions associated with the change in the model metrics Yₜ. As a consequence, the output of these steps can define a containing the following information in the root cause vector 209 (Rootcause2Vector), for example, and without limitation: index of the AI model that has an abnormal behavior that can be linked to the change in the application domain; metrics from the AI model domain that can be strongly associated to the changes; features that represent the transmission mechanism from the application domain to the AI model domain.

Still referring to FIG. 2, at 210, based on the root case vector 209, the system 106 can identify vectors for a first matrix, for instance a matrix 211, so as to generate the matrix 211 that can relate root causes with symptoms to varying degrees. Table 6 illustrates an example of the first matrix 211.

TABLE 6

| Root cause 1 | Root cause 2 | Symptom | |
|---|---|---|---|
| (application | (AI solution | (AI solution | Confidence |
| domain | domain) | domain) | level |
| Root cause 1 | Root cause 1 | Symptom 1 | Conf level 1 (1-1-1) |
| Root cause 1 | Root cause 2 | Symptom 1 | Conf level 1 (1-2-1) |
| Root cause 2 | Root cause 1 | Symptom 1 | Conf level 1 (2-1-1) |
| Root cause 2 | Root cause 2 | Symptom 1 | Conf level 1 (2-2-1) |
| . . . | . . . | . . . | . . . |

In particular, for example, based on the information in 201, 203, 205, 207, and 209, the system can generate the matrix 211 that directly relates root causes in the application domain with root causes in the AI solution domain, along with relevant symptoms and confidence levels. In an example, a vector can be defined with causal factors based on experiences in the field, wherein a confidence level indicates a likelihood of occurrence. Example defined vectors are shown in Table 7, and example observed vectors are shown in Table 8.

TABLE 7

| | Root cause 1 | Root cause 2 | Symptom | Defined |
|---|---|---|---|---|
| Defined | (application | (AI solution | (AI solution | confidence |
| vector | domain) | domain) | domain) | level |
| D1 | Root cause 1 | Root cause 1 | Symptom 1 | 25% |
| D2 | Root cause 1 | Root cause 3 | Symptom 1 | 90% |
| D3 | Root cause 2 | Root cause 1 | Symptom 1 | 50% |

TABLE 8

| | Input | Input | Input | Output |
|---|---|---|---|---|
| | Root cause 1 | Root cause 2 | Symptom | Calculated |
| Observed | (application | (AI solution | (AI solution | confidence |
| vector | domain) | domain) | domain) | level |
| O1 | Root cause 1 | Root cause 1 | Symptom 1 | 25% |
| O2 | Root cause 1 | Root cause 2 | Symptom 1 | 60% |

To determine and select an observed vector, the confidence level of an observed vector can be calculated based on the comparison between the observed vector and defined vectors. For example, the system can identify the defined root cause and symptom with the highest number of matches of causal factors and assign the defined confidence level to the calculated confidence level. If there are multiple matches with the highest number, the system can apply the following formula:

$$Calculated confidence level ( O , D ) = \frac{\begin{matrix}{\sum }_{i = 1}^{n} Match of causal factors ( defined vector D , observed \\ vector O )\end{matrix}}{n ( all causal factors )} \cdot Confidence level ( D ) .$$

If there are multiple matches, the match with the highest calculated confidence level can be identified. For example, with respect to vector O1 (Table 8) if only D1 matches all three causal factors, Calculated confidence level (O1, D1)=Defined confidence level (O1)=25%. In such an example, the above formula might not be needed because only one observed vector has the highest number of matches of causal factors. By way of another example, with respect to O2 (Table 8), D1 and D2 have two matching causal factors, so the formula above can be performed as follows:

$$Calculated confidence level ( O 2 , D 1 ) = \frac{2}{3} \cdot 25 \% = 16.7 \% .$$

$$Calculated confidence level ( O 2 , D 2 ) = \frac{2}{3} \cdot 90 \% = 60 \% .$$

Thus, the system can select highest calculated confidence level:

$$Calculated confidence level ( O 2 , D 2 ) = 60 \% .$$

It will be understood that the number of causal factors can depend on the domain, and thus can be more or less than 3. In some examples, the different causal factors can have different weights. In some examples, after an initial use of defined vectors, a machine learning (ML) model is trained to assign confidence levels to observed vectors.

Thus, links between first root causes (root causes associated with the application domain) and second root cases (root causes associated with the AI solution domain) can be established at 208. The relevant symptoms in the AI solution domain can be defined by the relevant changes in metrics identified above and/or the features that represent the transmission mechanism. Confidence levels can be generated via a variety of mechanisms.

In an example, a given confidence level is derived from a pre-defined set of rules that relate root causes and symptoms. By way of example, if a given f1 score drops and a pressure sensor increases, the application domain root cause is probably a broken valve. In an example, such a rule-based confidence level can be represented by a numerical representation by counting the share of rules that apply for a given application domain root cause. In another example, a given confidence level can be determined by a statistical strength of association. For example, in some cases, a statistical association can be established between an application domain root cause and a change in model metrics, such that p-values from Granger Causality tests can be used as the measure. In yet another example, a root cause classification model can be generated. For example, information from log matrices such as the matrix 211 (M1) can be used to create a classification system that maps symptoms and root causes. For example, the model can define a probability distribution over the possible root causes, so as to define measure that intrinsically indicate a confidence score (e.g., Random Forest, DNN with softmax activation in the last layer, etc.). Table 9 provides an example of confidence levels associated with two root causes (vectors), which can be selected at 210 so as to be defined by the first matrix 211, wherein confidence points 1-4 indicate low confidence, confidence points 5-8 indicate medium confidence, and confidence points 9-12 indicate high confidence. It will be understood that the two vectors are presented in Table 9 for purposes of example, and additional vectors can be identified based on alternative selection criteria (e.g., top 3 or top 4 vectors having a confidence level that is at least medium), and all such selection criteria are selecting vectors are contemplated as being within the scope of this disclosure.

TABLE 9

| | Vector 1 | Vector 2 |
|---|---|---|
| | Root cause | Root cause |
| | candidate 1; | candidate 2; |
| | Soldering | Transistor |
| Assessment criteria | paste changed | component changed |
| Causality between symptom (AI) | High (3) | Low (1) |
| and suggested cause (application) | | |
| Causality between suggested cause | Medium (2) | Medium (2) |
| (application) and suggested cause | | |
| (AI) | | |
| Time delay between cause | High (3) | Low (1) |
| (application) and symptom (AI) | | |
| Experience from last years | Low (1) | Low (1) |
| Total (Outcome) | High (9) | Medium (5) |

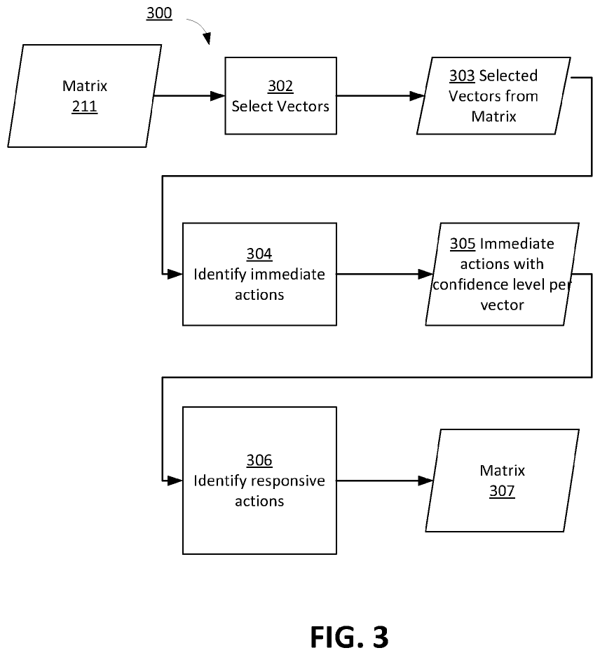

Referring now to FIG. 3, the computing system 106 can perform various operations 300 using the first matrix 211 as input. At 302, the system can select vectors (root causes) from the first matrix 211 that are associated with the highest confidence levels, so as to generate a subset of the first matrix 211 or a selected set of vectors 303. For example, the system can select vectors from the first matrix 211 that have a confidence level equal to higher than a predetermined confidence level threshold. At 304, based on the root causes (application and AI solution domains) and potentially additional conditions, the system select immediate actions, for instance immediate actions associated with sufficient confidence levels, so as to generate an immediate action vector 305. The immediate action vector can include, for example and without limitation, application root causes; AI solution root causes, one or more conditions, immediate actions, and confidence levels. Table 10 presents example data entries that can be included in the immediate action vector 305, which root causes and criteria are mapped to immediate actions.

TABLE 10

| Application | AI solution | Condition | Immediate | Confidence |
|---|---|---|---|---|
| root cause | root cause | 1 . . . n | action | level |
| Application | AI solution | Condition | Immediate | x % |
| root cause 1 | root cause 1 | 1 . . . n | action 1 | |
| Application | AI solution | Condition | Immediate | x % |
| root cause 1 | root cause 1 | 1 . . . n | action 2 | |
| Application | AI solution | Condition | Immediate | X % |
| root cause 1 | root cause 2 | 1 . . . n | action 3 | |

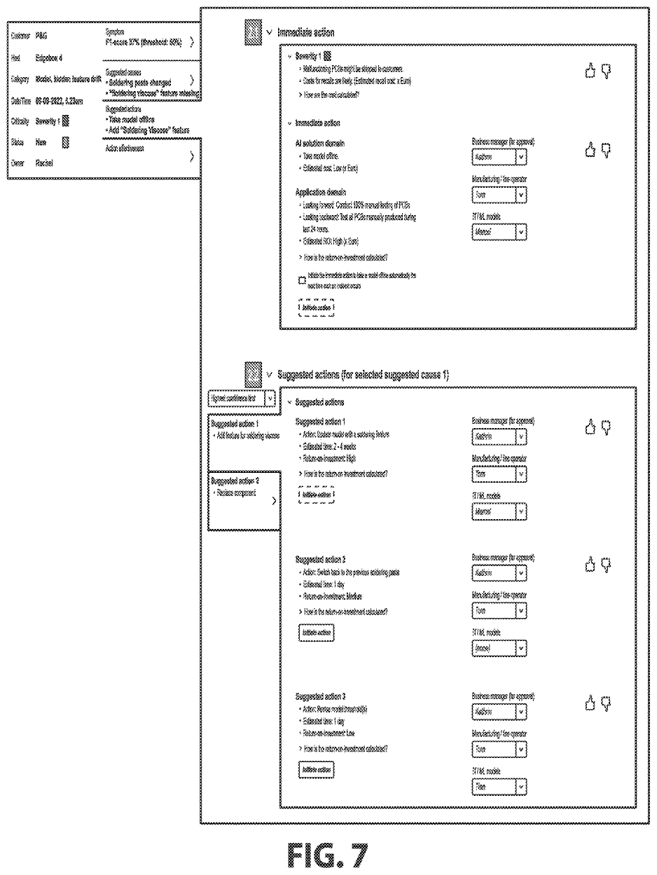

The confidence levels can be calculated with the conditions. For example, if a condition is true, it counts as 1. If a condition is unknown, it counts as 0. If a condition is false, it counts as −1. A formula for the calculation of the confidence level can be represented as:

$$CL ( ARC , AIRC , IA ) = \frac{{\sum }_{i = 1}^{n} ( {Condition}_{i} = true ) - {\sum }_{i = 1}^{n} ( {Condition}_{i} = false )}{n} ,$$

where −1≤CL≤1, and i is the number of conditions for a set of ARC (Application root cause), AIRC (AI solution root cause) and IA (Immediate action). An example of immediate actions is also shown in FIG. 7 (see element 2.1).

At 306, based on the immediate action vector 306, the system can determine or identify responsive actions with confidence levels, so as to define a second matrix 307 that maps root causes and criteria to immediate actions. For example, based on the root causes (application domain and AI solution domain) and potentially additional conditions, immediate actions with the highest confidence level can be selected and assigned to a vector, in particular the second matrix 307. The second matrix 311 can include, for example and without limitation, application root causes, AI solution root causes, one or more conditions, responsive actions, and confidence levels. Table 11 illustrates example data entries of the second matrix 311, so as to map root causes and criteria to immediate actions. An example of suggested or response actions displayed in a user interface is shown in FIG. 7, at 2.2.

TABLE 11

| Application | AI solution | Condition | Responsive | Confidence |
|---|---|---|---|---|
| root cause | root cause | 1 . . . n | action | level |
| Application | AI solution | Condition | Responsive | x % |
| root cause 1 | root cause 1 | 1 . . . n | action 1 | |
| Application | AI solution | Condition | Responsive | x % |
| root cause 1 | root cause 1 | 1 . . . n | action 2 | |
| Application | AI solution | Condition | Responsive | X % |
| root cause 1 | root cause 2 | 1 . . . n | action 3 | |

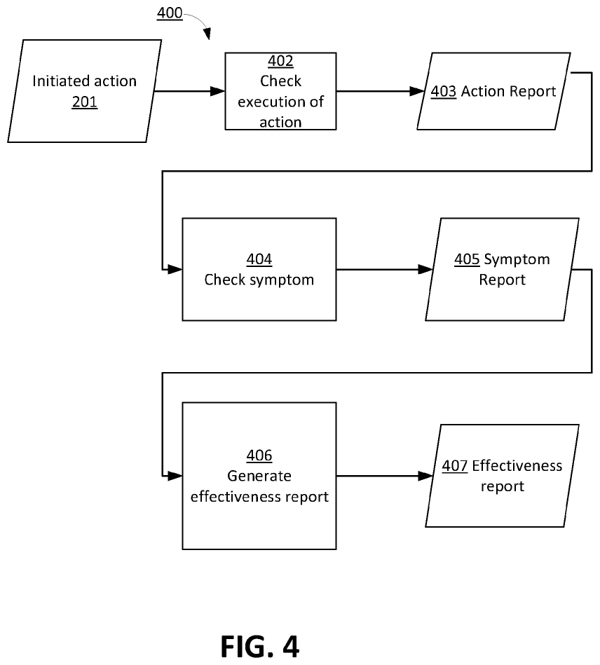

Referring now to FIG. 4, the computing system 106 can perform example operations 400 on the second matrix 311, so as to check whether an initiated action 401 from the matrix 311 was executed and whether the symptom, as a result of the initiated action 401, disappeared. After the check, the system can generate an effectiveness report 407. At 402, the system can perform and check the action 401 that is initiated from the matrix 311, so as to determine a status or action report 403 of the initiated action 401. The status 403 can indicate that the initiated action 401 is complete, in progress, or not started, among other states. Based on the action report 403, the system can determine a status of the symptom associated with the initiated action 401, at 404, so as to generate a symptom status or report 405. The symptom status or report 405 can indicate, for example and without limitation, that the associated symptom is resolved, improved, unchanged, or worsened. At 406, based on the symptom report 405, the system can generate the effectiveness report 407. The effectiveness report 407 can include relevant information, for instance all relevant information for the incident. The report 407 can include the root causes, the symptoms, the actions, and the results.

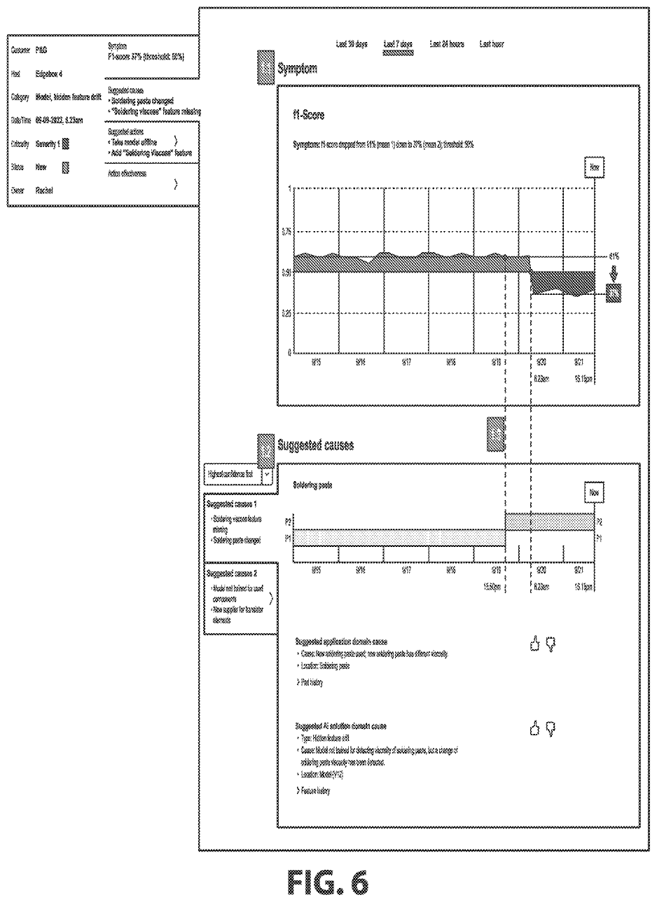

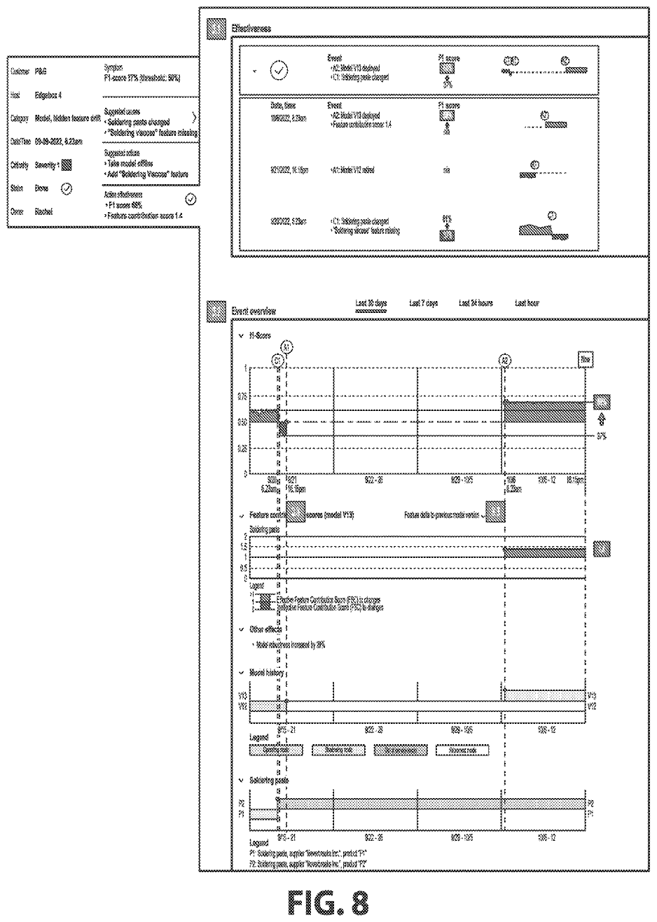

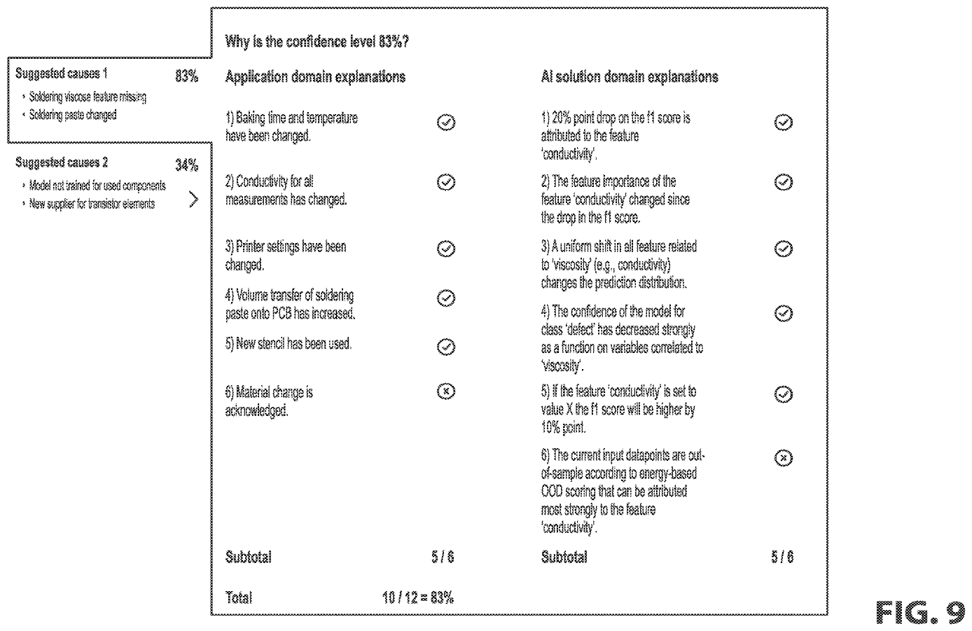

Referring now to FIG. 6-9, the computer system 106 can display various interfaces to a user or operator, for instance a first interface (see FIG. 6) a second interface (see FIG. 7), a third interface (see FIG. 8), and a fourth interface (see FIG. 9). It will be understood that the interfaces in FIGS. 6-9 are presented as examples, and the data on the interfaces can be alternatively arranged as desired, and all such alternative arrangements are contemplated as being within the scope of this disclosure. For example, an example of the effectiveness report 407 is shown in FIG. 8. FIG. 6 shows an example of a mapped symptom to an application and AI solution root cause (see element 1.1 for symptom, element 1.2 for root cause, and element 1.3 for mapping between symptom and root cause). The user interface of FIG. 7 illustrates an example of immediate actions (2.1) and suggested or responsive actions (2.2) that can be displayed to a user. FIG. 9 illustrates the calculation of a confidence level, based on checklists.

Thus, without being bound by theory embodiments described herein can automatically identify and report a deviation (or “symptom”) to a user via user interfaces. Furthermore, one or more possible root causes that are the reasons for the identified deviations (“suggested causes”) can be determined and displayed to users. One or more possible immediate actions (“immediate actions”) can be displayed to users. The system can automatically identify one or more possible responsible actions that resolve the root cause and that lead to the removal of the symptom (“responsive actions”), and such information can be displayed to a user. The AI solution domain system can render displays that explain why it has automatically selected suggested causes and suggested actions by calculating the confidence level via conditions that are true, unknown, and false. Furthermore, the system can automatically determine whether the initiated action was effective, meaning it has resolved the root cause and has removed the symptom. The mapping of symptom, root cause, and actions events across the different events in the causal chain can be displayed for the operator.

Thus, in accordance with various examples described herein, an industrial system can define a manufacturing domain and an AI domain. The industrial system can further define a computing system that can include a processor and a memory storing instructions that, when executed by the processor, configure the computing system to perform various operations. For example, the system can identify a change that occurs in the manufacturing domain of the industrial system. The manufacturing domain can define machines, materials, or processes configured to perform operations or produce an output. Based on the change, the system can select at least one AI component in an AI domain, so as to define a mapping between the change in the manufacturing domain and the at least one AI component. In various examples, the AI domain can be configured to monitor the manufacturing domain. Based on the mapping, the system can determine a first root cause for the change and a second root cause for the change. The first root cause can correspond to the manufacturing domain, and the second root cause can be associated with the AI domain. Furthermore, in an example, with reference to FIG. 6, the system can display a first visual depiction of the first root cause over a first timeline for an operator of the industrial system, and display a second visual depiction of the second root cause over a second timeline for an operator of the industrial system. As shown in FIG. 6, the second visual depiction can be displayed simultaneously with the first visual depiction, and the first and second timelines can be aligned with each other, such that the operator can easily view the relationship between causes in the manufacturing domain and the AI domain.

In various based on the change or event in the manufacturing domain, the system can extract metadata associated with the manufacturing system. Based on the metadata, the system can select the at least one AI component. The system can determine immediate actions responsive to the first root cause and the second root cause, wherein each of the immediate actions are associated with a confidence level. Furthermore, with reference to FIG. 7, the system can display the immediate actions and respective confidence levels to an operator of the industrial system. Based on the confidence levels, the system can select one of the immediate actions so as to define a responsive action. Furthermore, the system can begin executing, or trigger the execution of, the responsive action so as to define a responsive action execution. The system can monitor the responsive action execution and a symptom associated with the change, so as to determine an effectiveness of the responsive action. With reference to FIG. 8, based on the effectiveness of the responsive action, the system can generate an effectiveness report. In particular, for example, the system can display the effectiveness report to the operator, and the effectiveness report can indicate a score associated with the symptom over time.

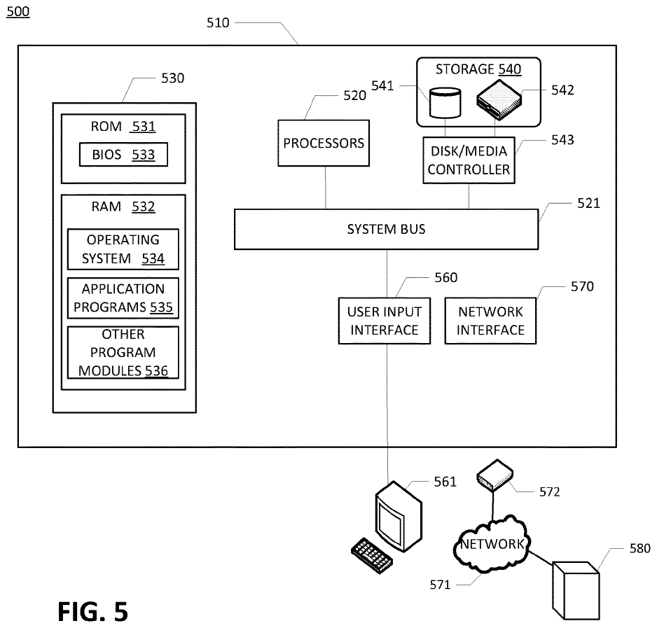

FIG. 5 illustrates an example of a computing environment within which embodiments of the present disclosure may be implemented. A computing environment 500 includes a computer system 510 that may include a communication mechanism such as a system bus 521 or other communication mechanism for communicating information within the computer system 510. The computer system 510 further includes one or more processors 520 coupled with the system bus 521 for processing the information. The computing system 106 may include, or be coupled to, the one or more processors 520.

The processors 520 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 520 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 521 may include at least one of a system bus, a memory bus, an address bus, or a message bus, and may permit exchange of information (e.g., data (including computer-executable code), signaling, etc.) between various components of the computer system 510. The system bus 521 may include, without limitation, a memory bus or a memory controller, a peripheral bus, an accelerated graphics port, and so forth. The system bus 521 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 5, the computer system 510 may also include a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 may additionally include, for example, operating system 534, application programs 535, and other program modules 536. Application programs 535 may also include a user portal for development of the application program, allowing input parameters to be entered and modified as necessary.

The operating system 534 may be loaded into the memory 530 and may provide an interface between other application software executing on the computer system 510 and hardware resources of the computer system 510. More specifically, the operating system 534 may include a set of computer-executable instructions for managing hardware resources of the computer system 510 and for providing common services to other application programs (e.g., managing memory allocation among various application programs). In certain example embodiments, the operating system 534 may control execution of one or more of the program modules depicted as being stored in the data storage 540. The operating system 534 may include any operating system now known or which may be developed in the future including, but not limited to, any server operating system, any mainframe operating system, or any other proprietary or non-proprietary operating system.

The computer system 510 may also include a disk/media controller 543 coupled to the system bus 521 to control one or more storage devices for storing information and instructions, such as a magnetic hard disk 541 and/or a removable media drive 542 (e.g., floppy disk drive, compact disc drive, tape drive, flash drive, and/or solid state drive). Storage devices 540 may be added to the computer system 510 using an appropriate device interface (e.g., a small computer system interface (SCSI), integrated device electronics (IDE), Universal Serial Bus (USB), or FireWire). Storage devices 541, 542 may be external to the computer system 510.

The computer system 510 may also include a field device interface 565 coupled to the system bus 521 to control a field device 566, such as a device used in a production line. The computer system 510 may include a user input interface or GUI 561, which may comprise one or more input devices, such as a keyboard, touchscreen, tablet and/or a pointing device, for interacting with a computer user and providing information to the processors 520.

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium of storage 540, such as the magnetic hard disk 541 or the removable media drive 542. The magnetic hard disk 541 (or solid state drive) and/or removable media drive 542 may contain one or more data stores and data files used by embodiments of the present disclosure. The data store 540 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 500 may further include the computer system 510 operating in a networked environment using logical connections to one or more remote computers, such as remote computing device 580. The network interface 570 may enable communication, for example, with other remote devices 580 or systems and/or the storage devices 541, 542 via the network 571. Remote computing device 580 may be a personal computer (laptop or desktop), a mobile device, a server, a router, a network PC, a peer device or other common network node, and typically includes many or all of the elements described above relative to computer system 510. When used in a networking environment, computer system 510 may include modem 572 for establishing communications over a network 571, such as the Internet. Modem 572 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 580). The network 571 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

It should be appreciated that the program modules, applications, computer-executable instructions, code, or the like depicted in FIG. 5 as being stored in the system memory 530 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 510, the remote device 580, and/or hosted on other computing device(s) accessible via one or more of the network(s) 571, may be provided to support functionality provided by the program modules, applications, or computer-executable code depicted in FIG. 5 and/or additional or alternate functionality. Further, functionality may be modularized differently such that processing described as being supported collectively by the collection of program modules depicted in FIG. 5 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 5 may be implemented, at least partially, in hardware and/or firmware across any number of devices.

It should further be appreciated that the computer system 510 may include alternate and/or additional hardware, software, or firmware components beyond those described or depicted without departing from the scope of the disclosure. More particularly, it should be appreciated that software, firmware, or hardware components depicted as forming part of the computer system 510 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method performed by a computing system associated with an industrial system, the method comprising:
identifying a change that occurs in a manufacturing domain of the industrial system, the manufacturing domain defining machines, materials, or processes configured to perform operations or produce an output;
based on the change, selecting at least one Artificial Intelligence (AI) component in an AI domain, the AI domain configured to monitor the manufacturing domain, so as to define a mapping between the change in the manufacturing domain and the at least one AI component; and
based on the mapping, determining a first root cause for the change and a second root cause for the change, first root cause corresponding to the manufacturing domain, and the second root cause associated with the AI domain.

2. The method as recited in claim 1, the method further comprising:
displaying a first visual depiction of the first root cause over a first timeline for an operator of the industrial system; and
displaying a second visual depiction of the second root cause over a second timeline for an operator of the industrial system,
wherein the second visual depiction is displayed simultaneously with the first visual depiction, and the first and second timelines are aligned with each other.

3. The method as recited in claim 1, the method further comprising:
based on the change, extracting metadata associated with the manufacturing system; and
based on the metadata, selecting the at least one AI component.

4. The method as recited in claim 1, the method further comprising:
determining immediate actions responsive to the first root cause and the second root cause, each of the immediate actions associated with a confidence level.

5. The method as recited in claim 4, the method further comprising:
displaying the immediate actions and respective confidence levels to an operator of the industrial system.

6. The method as recited in claim 5, the method further comprising:
based on the confidence levels, selecting one of the immediate actions so as to define a responsive action; and
executing the responsive action so as to define a responsive action execution.

7. The method as recited in claim 6, the method further comprising:
monitoring the responsive action execution and a symptom associated with the change, so as to determine an effectiveness of the responsive action.

8. The method as recited in claim 7, the method further comprising:
based on the effectiveness of the responsive action, generating an effectiveness report; and
displaying the effectiveness report to the operator, the effectiveness report indicating a score associated with the symptom over time.

9. A computing system of an industrial system, the computing system comprising a processor and a memory storing instructions that, when executed by the processor, configured the system to:
identify a change that occurs in a manufacturing domain of the industrial system, the manufacturing domain defining machines, materials, or processes configured to perform operations or produce an output;
based on the change, select at least one Artificial Intelligence (AI) component in an AI domain, the AI domain configured to monitor the manufacturing domain, so as to define a mapping between the change in the manufacturing domain and the at least one AI component; and
based on the mapping, determine a first root cause for the change and a second root cause for the change, first root cause corresponding to the manufacturing domain, and the second root cause associated with the AI domain.

10. The computing system as recited in claim 9, the memory further storing instructions that, when executed by the processor, further configure the system to:
display a first visual depiction of the first root cause over a first timeline for an operator of the industrial system; and
display a second visual depiction of the second root cause over a second timeline for an operator of the industrial system,
wherein the second visual depiction is displayed simultaneously with the first visual depiction, and the first and second timelines are aligned with each other.

11. The computing system as recited in claim 9, the memory further storing instructions that, when executed by the processor, further configure the system to:
based on the change, extract metadata associated with the manufacturing system; and
based on the metadata, select the at least one AI component.

12. The computing system as recited in claim 9, the memory further storing instructions that, when executed by the processor, further configure the system to:
determine immediate actions responsive to the first root cause and the second root cause, each of the immediate actions associated with a confidence level.

13. The computing system as recited in claim 12, the memory further storing instructions that, when executed by the processor, further configure the system to:
display the immediate actions and respective confidence levels to an operator of the industrial system.

14. The computing system as recited in claim 13, the memory further storing instructions that, when executed by the processor, further configure the system to:
based on the confidence levels, select one of the immediate actions so as to define a responsive action; and
trigger the responsive action so as to define a responsive action execution.

15. The computing system as recited in claim 14, the memory further storing instructions that, when executed by the processor, further configure the system to:
monitor the responsive action execution and a symptom associated with the change, so as to determine an effectiveness of the responsive action;
based on the effectiveness of the responsive action, generate an effectiveness report; and
display the effectiveness report to the operator, the effectiveness report indicating a score associated with the symptom over time.
